(19) United States
(12) Patent Application Publication
(10) Pub. No.: US 2002/0123904 A1
(43) Pub. Date: Sep. 5, 2002

(54) Internet shopping assistance technology and e-mail place

(76) Inventors: Juan Amengual, Torre Banhorient (ES); Eduardo Arnal, Torre Banhorient (ES); Ronald Cabrera, Torre Banhorient (ES); Daniel Carrasco, Torre Banhorient (ES); Jose Marquez, Torre Banhorient (ES); Ana Puig, Torre Banhorient (ES)

Correspondence Address: GREENBERG TRAURIG, P.A., 1221 Brickell Avenue, Miami, FL, 33131, US

(21) Appl. No.: 10/078,142

(22) Filed: Feb. 19, 2002

Related U.S. Application Data
(60) Provisional application No. 60/271,026, filed on Feb. 22, 2001.

(51) Int. Cl. G06F 17/60

(52) U.S. Cl. 705/1

(57) ABSTRACT

The present invention is a customizable system and method for direct access to a specified Internet website and related/alternate websites and to reach e-mail addresses utilizing telephone numbers as primary search queries. The browser's graphical elements and layout can be customized to suit the user's preferences or other criteria such as geographical circumstances, language, or to match the specified website's graphical elements and layout. The browser system is preferably embodied in a comprehensive Internet portal offering an instantly created referential and search-helping directories system structure that is formed around a website as it is entered from the portal by means of either: its domain name or URL-numeric, or a common telephone number belonging to such website. It also includes an e-mail organizing function based on the same basic system. The e-mail function is capable of concentrating in a customizable website a plurality of e-mail boxes belonging to the same owner in order to provide a classification service for his incoming messages.

### BACKGROUND OF THE INVENTION.

1. Field of the Invention

The present invention relates to a streamlined system for the exchange of information and commerce via computer networks. More particularly, the present invention relates to a customized information targeting device system and method for direct access to specified Internet websites and related/alternate websites utilizing telephone numbers as search queries. The present invention is also a system and method for access to specified e-mail addresses utilizing telephone numbers as search queries.

2. Description of Related Art

The Internet is a network of computers communicating using common protocols, with each server computer and page of the World Wide Web service having a specific, unique address. There is an enormous amount of information available on the Internet, but it is often difficult for consumers to find. Internet usage and communications are typically accomplished through the use of a “browser.” A browser is a software application that facilitates an end user's communication with a particular address on the Internet, allowing linking to and downloading of files from the particular address. A modem is connected to a telephone line under control of a software application called a “dialer” in order to establish a telephonic connection to the Internet via an Internet Service Provider. Alternatively, connection to the Internet can be via an ISDN line or other direct Internet connection, local area network or wide area network.

With the dramatic growth of Internet usage, many businesses have developed websites to provide potential and existing customers with information about their business, products or services. Many also provide facilities for completing purchase and/or other business transactions online through the business' websites.

Each website is designated by an Internet address in the form of a series of numbers such as “123.45.67.8.” In order to make website addresses easier to remember and more recognizable, domain names such as “www.xyz.com” have been developed to associate with the numerical addresses. Nevertheless, even domain names can be difficult to remember and enter correctly. Furthermore, with the huge growth in the number of websites on the Internet, competition for business is becoming more intense. A business with a simple and effective method for bringing a consumer to its website will have a competitive advantage over other businesses that lack such methods.

While the Internet has gone far in expanding global communications and electronic commerce, it is not yet as useful for more local communications or more particular commerce websites. It is often harder to find the local pizza delivery service than to find out about how pizza is made, or pizza delivery services in other regions that have the resources to advertise on one or more of the major search engine portals.

Existing directories and search helping devices fall short when applied to E-commerce. As a directory of businesses, yellow (and white) pages offer a guarantee of universal inclusion (within the service area of the telephone company or some times enlarged areas around a city) since every business is given one entry in its category regardless of payment but websites are not always included in the information they provide. Regarding their intended use (i.e., as auxiliaries of the telephone system), the printed nature of the book limits the quantity and quality of the information offered and does not permit automated order preparing nor on line ordering, or even updating the information in a timely manner. Search engines, when applied to help consumers seeking a determined website, are not secure and require tedious searches through large pluralities of entries often referring to sites that are useless or unrelated to the desired subject, thus adversely affecting the usefulness and value of the category directory they provide. Interactive automated voice telephone answerers offer useful guides to determine the appropriate department or service of an organization, but they do so through long audio explanations and instructions which cannot be repeated but with the full message, as forced by the audio-only nature of the telephone medium. Direct entering of URLs offers no help to the consumer as to alternatives searching, as telephone directories do.

Using telephone numbers as an alternative way for accessing web pages is a stated purpose of the Internet Engineering Task Force, which has set up a working group to develop the ENUM initiative. A number of different devices have been proposed for the purpose of individually mapping, translating, converting or otherwise “intelligently” using telephone addressing codes (or numbers) to reach individual corresponding websites. E-mail service has also experienced a dramatic growth and is also in need of organizing devices that would help senders and addressees simplify their task since it has even less assisting devices than websites have.

3.—Distant Shopping Expedients and the Internet Environment.

Distant shopping assistance is dominated by: Catalog ordering; Telephone Directories both printed and electronic; Telephone Assistance Expedients, whether humanly attended or by automatic answerers; Internet Search Engines and browser/server-assisted domain name simplification; and Domain Name direct entering, whether in its present stage or by ENUM enabled means.

Catalog shopping assisted by regular mail or telephone ordering was the first expedient to appear and its basic principle is still the model used by the Internet's e-commerce, and has been greatly enriched and enhanced by the electronic nature of the Internet.

Yellow pages searching has become the single most important assistance consumers can use at the present time to conduct distant shopping for either direct ordering or choosing or locating individual stores.

In an e-commerce perspective the universe of commercial websites can be viewed as a basic catalog of single and multi-layered subcatalogs, with the domain names system playing the role of an index code. However, accessing websites one by one is not effective because of the huge amount of websites and the unsatisfactory ways of entering them through long strings of alphabetical and punctuation signs and that of not having them handily compiled for consumers. A second drawback affecting individually entering desired websites consists in the fact that, if the intended search or contact fails to give a satisfactory result the consumer must start all over again from the beginning, i.e., looking for another domain which could provide a suitable alternative.

The ENUM initiative is intended to render domain names capable of storing or implying common telephone numbers corresponding to the respective web pages. A number of systems and devices have been studied and proposed to make use of this foreseen possibility to allow accessing websites by invoking corresponding telephone numbers, this possibility would help consumers to search websites by a way that is easier and more convenient than domain name entering. However, in the event of unsuccessful or unsatisfactory website search, the user would still have to look for a suitable alternative from the start, unassisted by the ENUM type device, which inherently deals with individual websites and corresponding individual telephone numbers, this fact forcing the user to spend unnecessary time and effort.

Search engines and browser services have gone a long way to simplify the task of entering long and complicated strings of alphabetic characters written in unusual ways. This has been achieved to a remarkable degree but at the cost of giving as a result long lists of entries, many of which are utterly irrelevant, and requiring long tedious searches by the consumer, not necessarily resulting in accessing to the desired target, all of which often results in the abandoning of the search.

The former is the background against which we now proceed to analyze each one of the existing distance shopping expedients and to cross-evaluate them as we compare each one of them with the present invention.

The desirable features for systems designed to assist consumers in their buying can be summarized as: (a) target accuracy (regarding the subject of the searched product or service); (b) provision of ready alternatives, (so as to maximize the choice and the value of the buying); (c) convenience (so as to easily access the searched product or service and store useful information regarding the consumer) in order to avoid unnecessary repetition of customer's data; (d) reliability, provided by guaranteeing that asking the right query provides the desired results; (e) time and effort saving, involving provisions to bestow efficiency in user actions.

Cross evaluating those distant shopping expedients in consideration of desirable features and characteristics, we find that:

Yellow pages are accurate and provide ready alternatives, as to businesses, geographical locations and some other data. As to convenience, they bear a particularly handy form and adapt remarkably well to the function of a wide and general catalog of shopping possibilities. Their printed form lends itself well for quick searches through its classified structure: yellow pages use a short, familiar and friendly code, that of the telephone system, while storing information in an easy to consult format. It is not endowed, speaking in general terms, with any feature allowing the user to facilitate his task of grouping entries by area locations or any criteria other than the alphabetical order, consumers having to highlight manually those entries arousing their interest in order to conduct a telephonic search. The printed nature of its basic embodiment causes it to be updated only yearly and to be passive and hence devoid of time and effort saving features for being unable to react to the user's perceived needs and incidents occurring as the search is being conducted.

Telephone searching, whether answered by persons or by automated answerers, are accurate in reaching the desired party and benefit from the support of comprehensive directories. In case of changes in number, telephone companies customarily provide information that allows keeping the contact, which provides reliability. On the other hand, telephone calling rates poorly when compared with the richness of content and speed of information gathering that is associated with Internet searching. It offers no alternatives display, it can store no information regarding the customer and it can do nothing to save any part of the time and effort put in a failed link if the contact achieved does not prove successful or satisfactory.

In the Internet field, e-commerce is endowed with the capacity of a boundless virtual catalog of catalogs, further enriched by the interactive ability and immediate updatability as inherent to its electronic nature. This all adds-up to make e-commerce an incomparably powerful means to assist distant shopping on a previously unknown scale. As to assistance expedients regarding this field, two different approaches have been devised: category searching and direct entering of DNS.

The problem standing in the way of an easy and convenient method of targeting a determined website has been created by the very success of the Internet and the e-commerce. It is a well known fact that the WWW's URL/DNS address systems were created for a smaller network than the Internet has come to be. The quality of the system's design, however, has allowed the Internet to exceed its creator's expectations and the incorporation of a great and beneficial e-commerce activity. However, with the growth of e-commerce has come a body of confusing domain names marred by lots of similar names, composed of large strings of letters and punctuation marks and/or strange words written in unusual ways which is not surprisingly prone to mistakes. Attempts to deal with the consequent difficulty in accessing websites have included category search services provided by search engines and browser/server assisted domain name simplification. However, such searches result in very large lists of entries making it burdensome and tiring to examine them until the desired one appears, and a hazardous verification of likely candidates many of which lead to wholly different fields from which it could be difficult to return to the desired searching list. Large numbers of clicks often result in abandoned searches.

A solution to this dilemma has been envisioned by the Internet Engineering Task Force's ENUM initiative. It has the purpose of enlarging the DNS structure and that of its components, doing it in such a manner that would allow individual telephone numbers to be implied or referred in the corresponding website domain name. This initiative is in its early stages and the main concern at the present time is to develop an industry consensus on the best code protocol. Once that point is reached, the new IP will be approved but no “intelligent” way of making use of it will be enacted, such applications being left to individual developers to invent.

As to target accuracy, DNS entering or (in a future time, as it is to be expected) ENUM enabled telephone number entering are satisfactory means of accessing individual websites, while category search cannot be so considered. In fact, circumventing the dilemma posed by the burdensome entering of many long and strange looking domain names, on one side, and searching through long lists resulting from the category search methods, on the other, is the only virtue of ENUM-enabled telephone numbers, along with them pertaining to the same website organization, and to the corresponding telephone code. That is the only advantage this change in coding protocol and subsequent applications brings to the field of Internet distant shopping. Regarding providing ready alternatives, search engine assisted searches do offer alternatives, while DNS and ENUM enabled number entering do not. As to convenience in accessing the searched place, ENUM numbers make it an easy step for the user, but none of the aforementioned Internet shopping expedients, including ENUM, can store user information to transmit to different websites in order to avoid inconvenient repetition of commonly asked consumer data as address, e-mail, name, passwords, etc.

None of the Internet accessing expedients provide any reliability of the search in case of a change in the addressing code used (while telephone calling does) and no time and effort saving device is included in neither of them in case of incidental link failure, i.e., for called server overload or routing mishap.

As a result, ENUM enabled telephone numbers are a step in the right direction as to the facility of website code entering, and besides it enjoys the benefit of sharing a common code with the telephone service, sharing with it the help provided by telephone directories. But as a distance shopping expedient, it still lacks many consumer convenience providing features, and leaves ample room for improvement, as following paragraphs will show.

The present invention, referred to as “Internet Shopping Assistance Technology” or ISAT aims to offer all of the desirable aspects of the existing and known distant shopping assistance expedients plus some new features which the electronic nature of the net allows:

As to target accuracy, it is based on the best code available, reinforced by the appearance of both, telephone number and organization's name in the first screen of its portal for verification of input.

ISAT provides the best of all possible shopping alternatives gathering methods, since it centers in a determined website telephone number which already implies a geographical location, a particular specialty or line of business and customer requirements, as allowed by the database selection and its stored information from websites, telephone directories and user's profile and preferences. All this information allows for the intelligent organization of a “Referential Directory” gathered around a business that has been queried providing ready alternative products, services and sources based on the user's initial query.

Convenience in ISAT use includes not only ease of entering a desired website code but also a verification feature of both the number and corresponding organization's name, and the efficiency of entering a single query while benefiting from the consequent reporting of multiple websites sharply related to the intended search. It also stores commonly needed data regarding the user, so as to eliminate the need to re-enter duplicate user information when conducting various distant shopping processes.

ISAT reliability rests on the instant updatability of changes in accessing codes and in providing websites with the outdated code (telephone number or DNS) as a “floating” interim alternative address to be maintained for a determined period of time in which both outdated and updated codes will be operational so as to avoid losing contacts for affected websites, while giving notice also of the new address code.

All of the above mentioned features make for a system endowed with an unprecedented time and effort efficiency combination to help consumers in their e-commerce searches, but the target-centered reference system and the user customization possibilities stand as new and particularly useful expedients, and the failed links storing function in view of an eventually desired recall at a later time provides an additional new way to save users time and effort.

Similar assistance features are lacking in the e-mail service of the Internet. This extraordinary communication device is marred by spamming and superfluous, undesired or excessive messages that make it difficult or burdensome to sort incoming interesting and/or useful information. The present invention provides an e-mail service that provides verification data pertaining to the e-mail addressee and other useful information. Further, the same information and data gathering methods and systems used for the web portal are used in the e-mail sub-portal in order to facilitate message sending, to classify different kinds of messages and to stabilize contacts in case of changes in telephone numbers or e-mail addresses. This e-mail communications assistance system by means (in a preferred embodiment) of a portal rests on the same basic principles and devices, constitutes an integral part of this invention and, further, it is to be used as an inducement to the use of the e-commerce function of the system by consumers. Both the e-mail organizing and redirecting function and the shopping assistance function share the same portal home page, thus each contributing to exposure and traffic-building of the other.

### SUMMARY OF THE INVENTION

The present invention is a customizable web page targeting system and method, universal in nature, for direct access to specified Internet websites and related/alternate websites utilizing telephone numbers as basic search queries. It constitutes a comprehensive system for assisting customers in their Internet shopping. “Internet Shopping Assistance Technology” or ISAT is preferably embodied in a comprehensive Internet portal offering an instantly created referential and search-helping directory and other auxiliary directories and devices. The referential directory structure is formed around a website as it is entered by either its domain name, its URL-numeric or a common telephone number belonging to a website, upon a user of the portal entering such number, or URL (numeric or domain name service).

As a method of doing business, the system includes listing all available websites free of charge or other conditions to either the website or the user, thus guaranteeing the universal and unrestricted access of all websites by consumers. The system can be utilized to generate revenues through multiple telephone number listing, sale of advertising and preferential forms of being listed as an alternative business search result for one or more targeted businesses.

The present invention establishes a link not only between the telephone code and the Internet's URL, but also between the universe of websites and that of the telephone directories. These books are ubiquitously placed within easy reach of every consumer and are frequently utilized when they are about to shop for a great deal of products and services. Their printed and physical nature and the familiarity of consumers they enjoy, make them an ideal and widely used device to start a search for shopping products or services for which having some sort of information is necessary or advisable. In this context, the system of the present invention enhances searches initiated through printed telephone directories and other advertising media by enriching, supplementing and updating the information they can hold, further adding the possibilities of order preparing and online transaction capacities. In this respect, printed directories are used as vehicles to portray the existence of corresponding web pages, the features they contain and the possibility of reaching them through the same number used to make telephone calls, by means of the system's portal.

The present invention does not involve any special information transformation or manipulation device, but rather simply compiles from the proper original sources all websites and their corresponding telephone numbers, and store them in a database in order to depict website name and corresponding telephone numbers adjoining each other, and then offering the result as a universal alternative access way for all websites at no cost for websites or users.

The present invention offers consumers access to a full directory of websites linked to their corresponding telephone numbers. All telephone numbers worldwide can be included. The system's telephone number/domain name data processing can be used to access websites through various telephone numbers for the same business, such as fax numbers and individual extensions.

In order to satisfy consumers' natural desire to consider and compare purchase alternatives, the system provides a referential directory endowed with links and telephone numbers for alternative businesses in the same field as the business originally queried. In this manner, the present invention provides a method for a telephone-listing directory classified by related businesses. This referential directory is customizedly constructed around every individual website to appear when it is queried, for the purpose of offering shopping alternatives to the calling consumer that are particularly relevant to such query (instead of following alphabetical order as yellow pages, or random listing, as search engines do). The web portal of the present invention provides features that, at the present time, are only partially offered within separated fields by: the web, telephone directories, search engines and telephone special services such as automatic answerers and reference services. The services provided by the directory structure of this invention could also be obtained by entering the searched website by means of its domain name or its numeric URL.

The system utilizes known Internet communications protocols, links and hardware. Users of the system use and access the system through computer terminals or other Internet access devices connecting to the system through known methods of Internet connection and communication.

The combination of elements comprising the present system results in a system that can be easily used by any computer user, allowing advertisers to direct traffic to their website simply and inexpensively. In addition to this, consumers can be directed to other marketing activities as getting forms and obtaining additional information by downloading, examining or proceeding to order preparation through the corresponding website, instead of telephone calling. As a matter of fact it will be more convenient and rewarding for the consumer, when in possession of a telephone number, to conduct his shopping search through the web than if he called the party's numbers through the telephone. The present invention provides the following benefits, among others: It is more reliable since it provides a remedy for any change occurring in the URL, in the domain name or even in the telephone number of the owner. It can be used with currently existing technology and coding standards or in the event of any evolution of either, and its universal and irrestricted character tends to attract consumers to its generalized and habitual use.

The system provides (in one of the embodiments of the invention) a “porch” portal to the website in order to depict in a clear and standardized way, which consumers would become familiar with, the content or index of the site, thus saving the visitor the burden of readapting his mind setting at each jump from one website to the next, to successively assimilate the different structures and organizations of different websites. This feature also permits users to enter websites through desired subpages or sections, thus saving the inconvenience of finding one's way through often massive and complicated websites. Another feature allows user to structure their search by pre-selecting and placing in a side bar of the screen certain websites in view of a consecutive search.

### BRIEF DESCRIPTION OF THE DRAWINGS

### All of Them Showing Functions and Features in a Preferred Embodiment

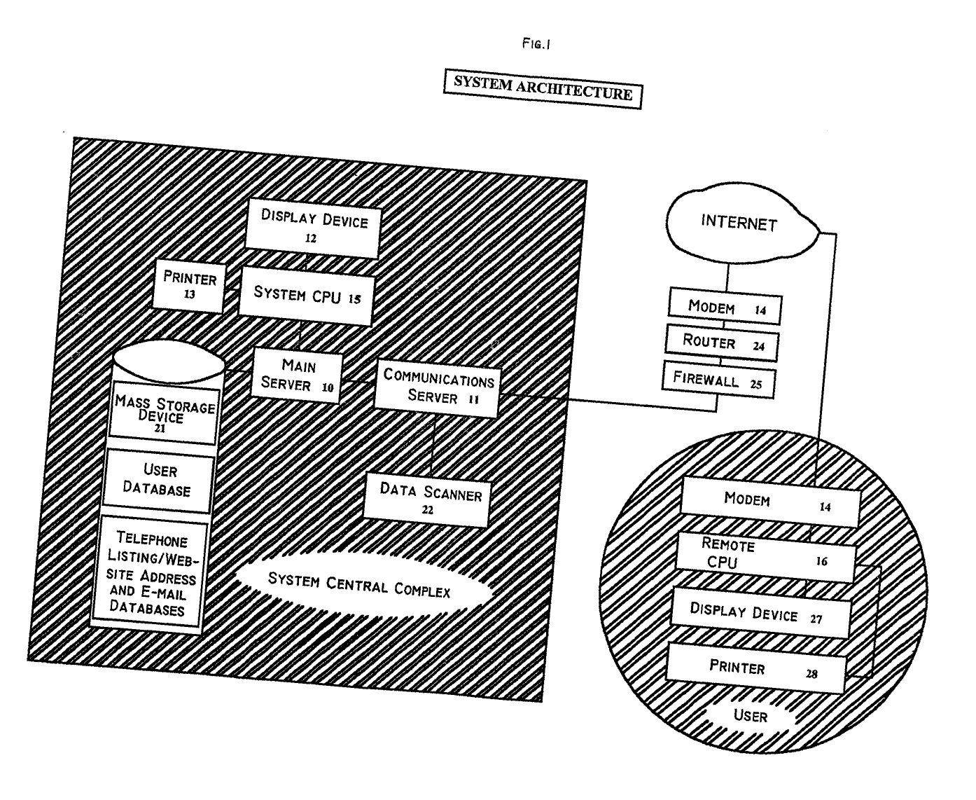

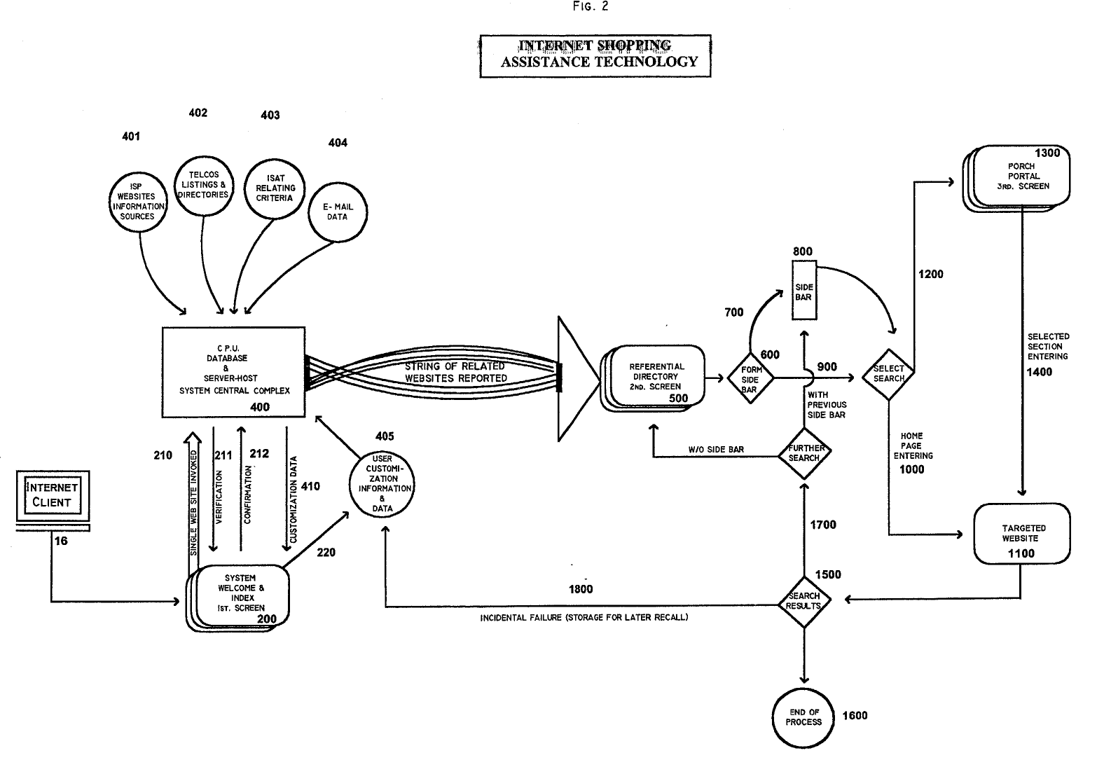

FIG. 1 is a diagram of the system architecture of the present invention.

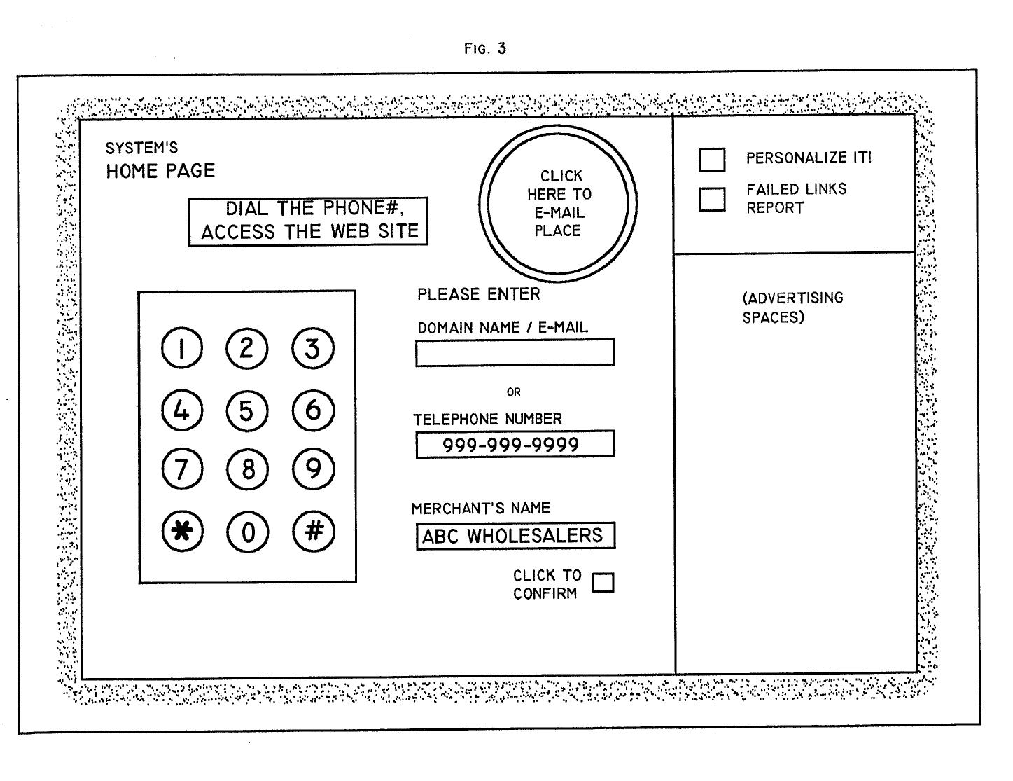

FIG. 2 is a flow chart diagram describing the overall process flow of the search process of s the present invention.

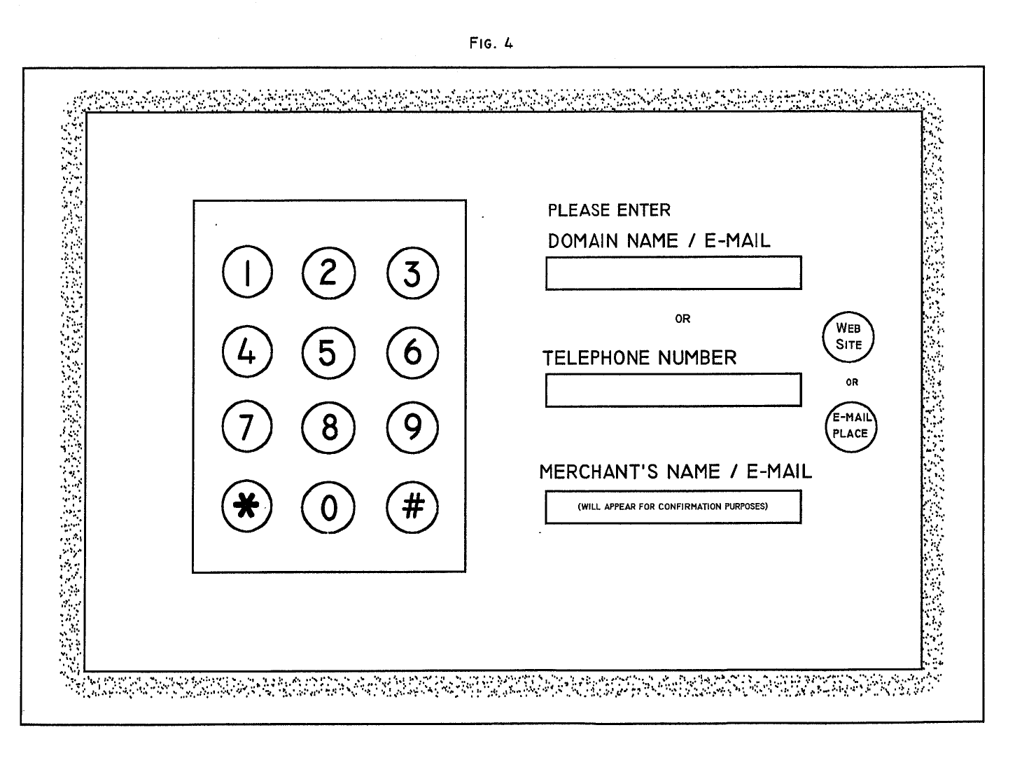

FIG. 3 is a sample of the initial “Welcome/Home” screen of the portal of the present invention, showing a website requested.

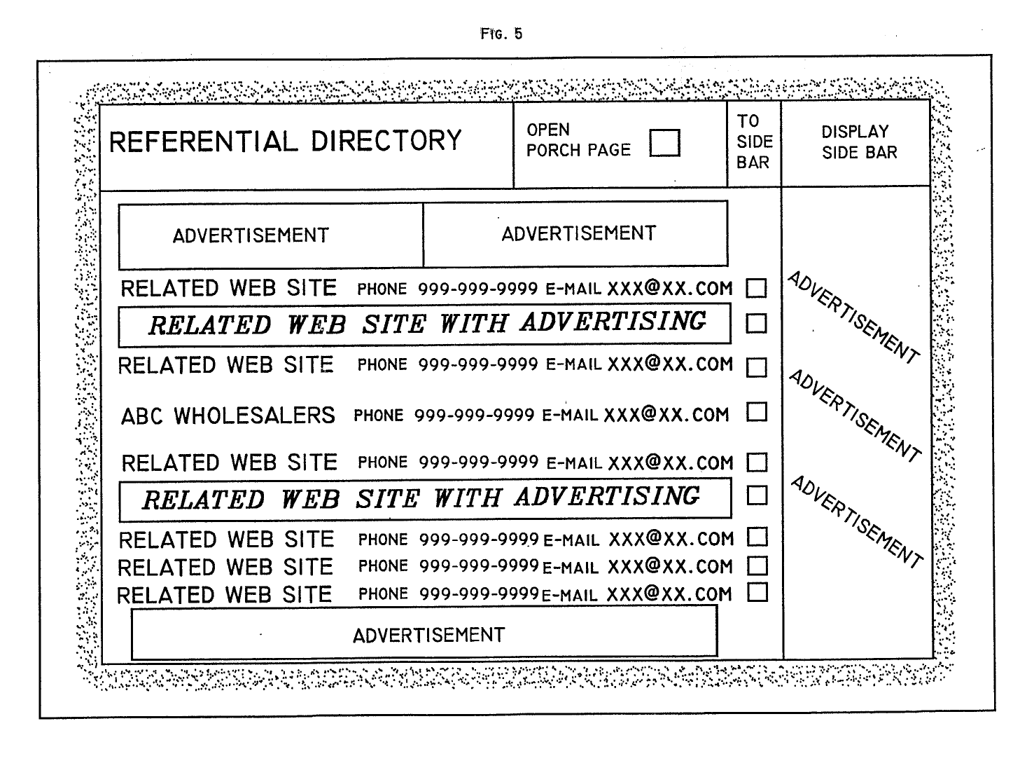

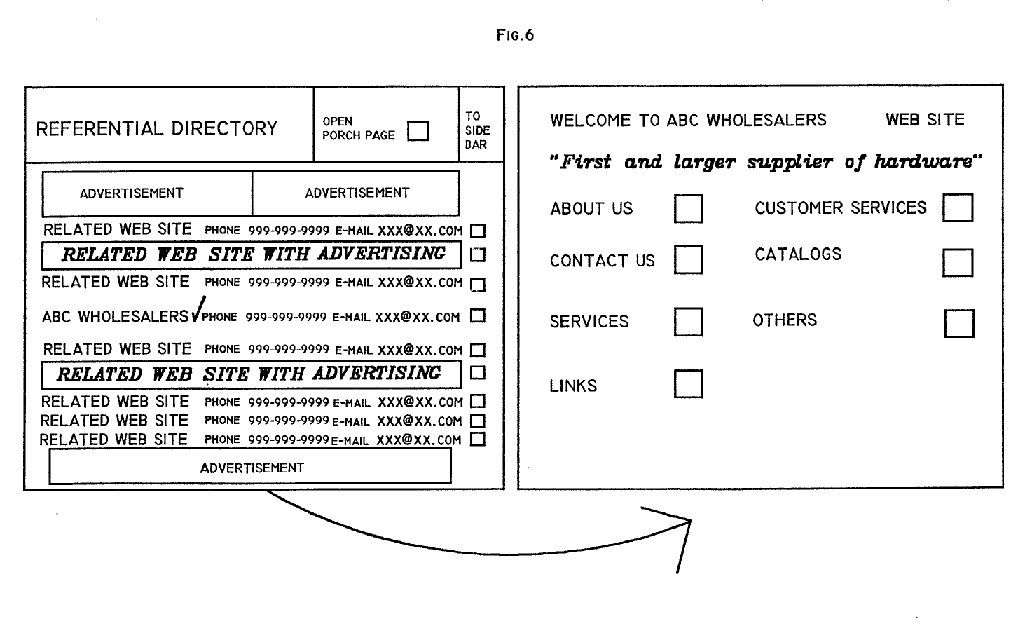

FIG. 4 is a sample of the keypad image displayed to users of the portal of the present invention.

FIG. 5 is a sample referential directory screen of the portal of the present invention depicting the website requested in FIG. 3, along with additional alternate sites.

FIG. 6 is a sample search results screen of the “referential directory” of the present invention, depicting the link to a desired website.

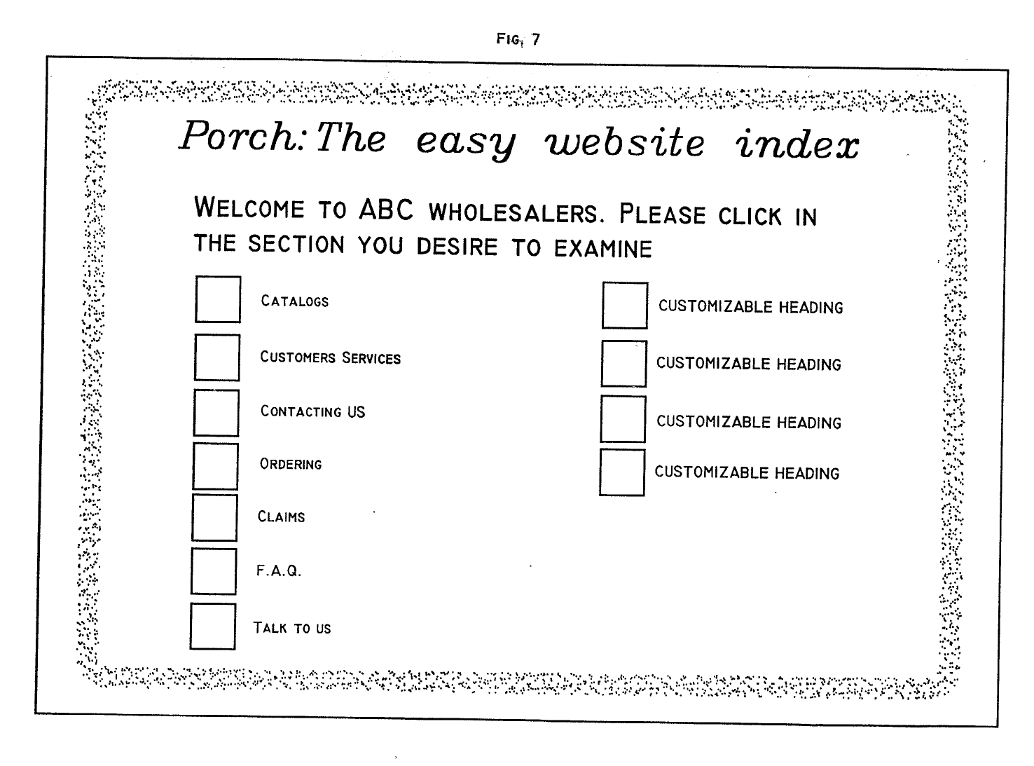

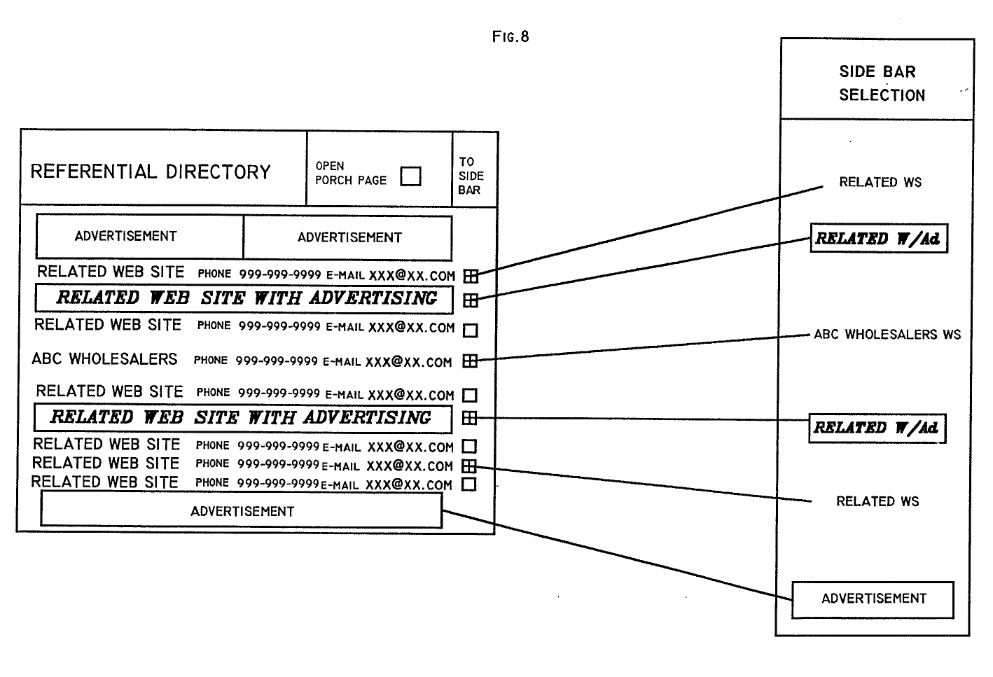

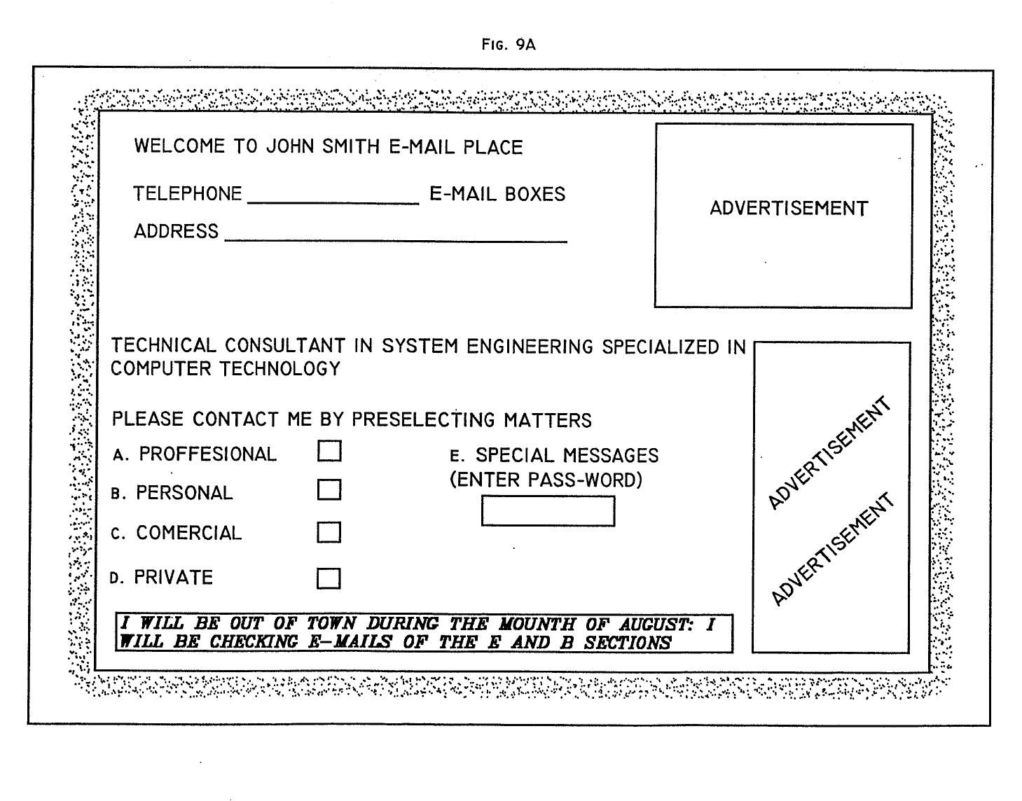

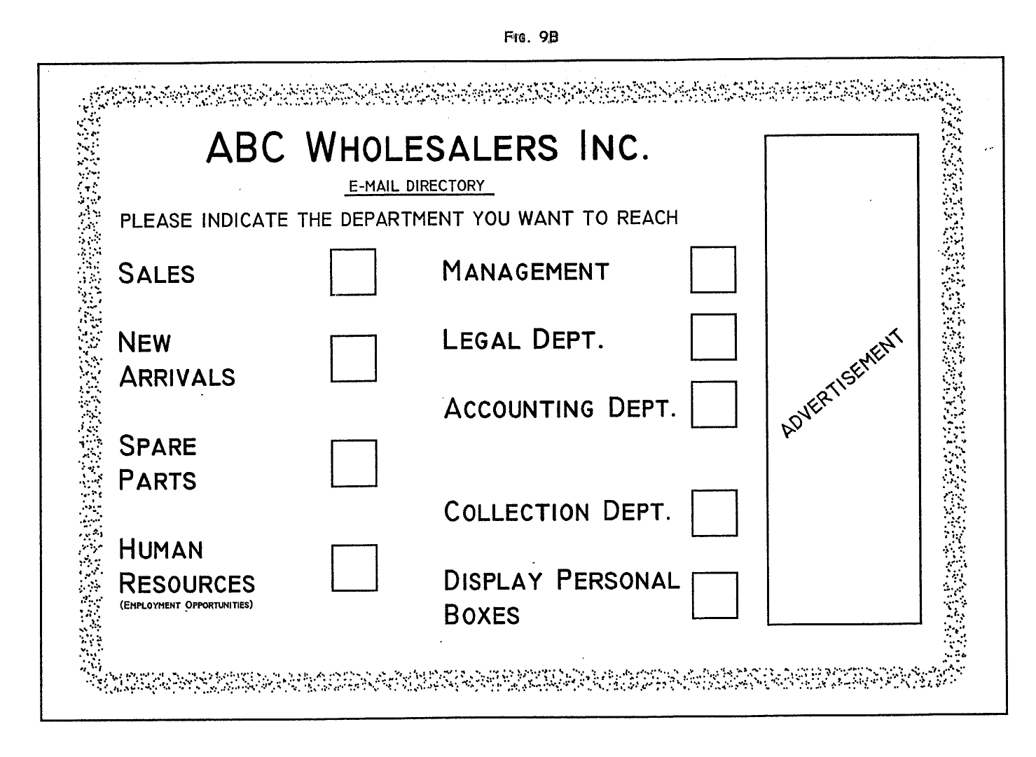

FIG. 7 is a sample of the “porch” screen of the portal of the present invention.

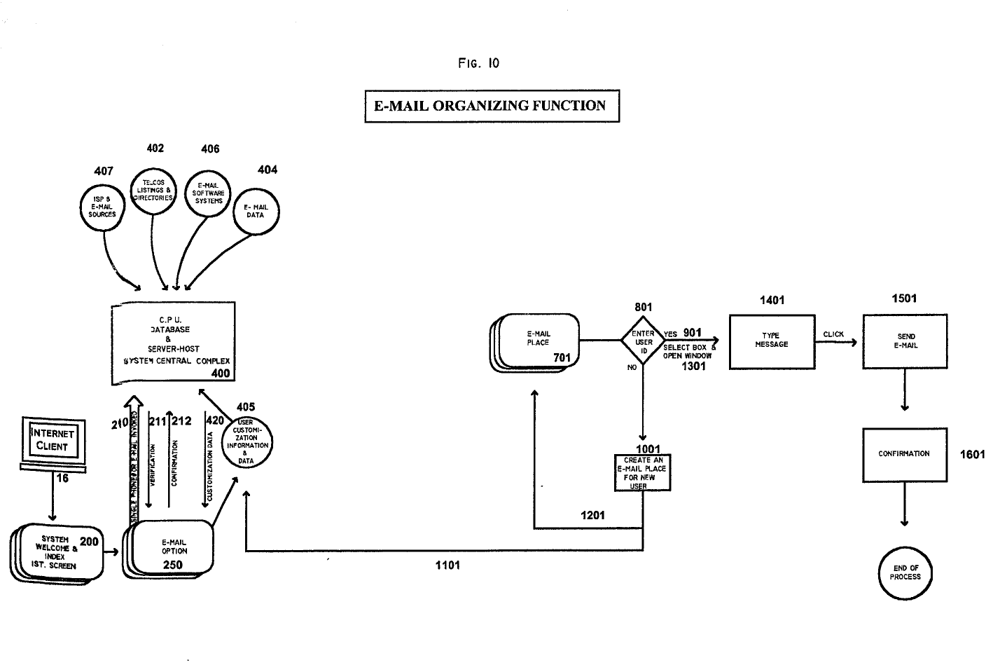

FIG. 8 is a sample of the side bar for pre-selected sites to be searched.

FIGS. 9A and 9B are samples of the e-mail sub-portal of the portal of the present invention. 9A referring to persons and 9B to businesses.

FIG. 10 is a flowchart of the e-mail organizing function of the system.

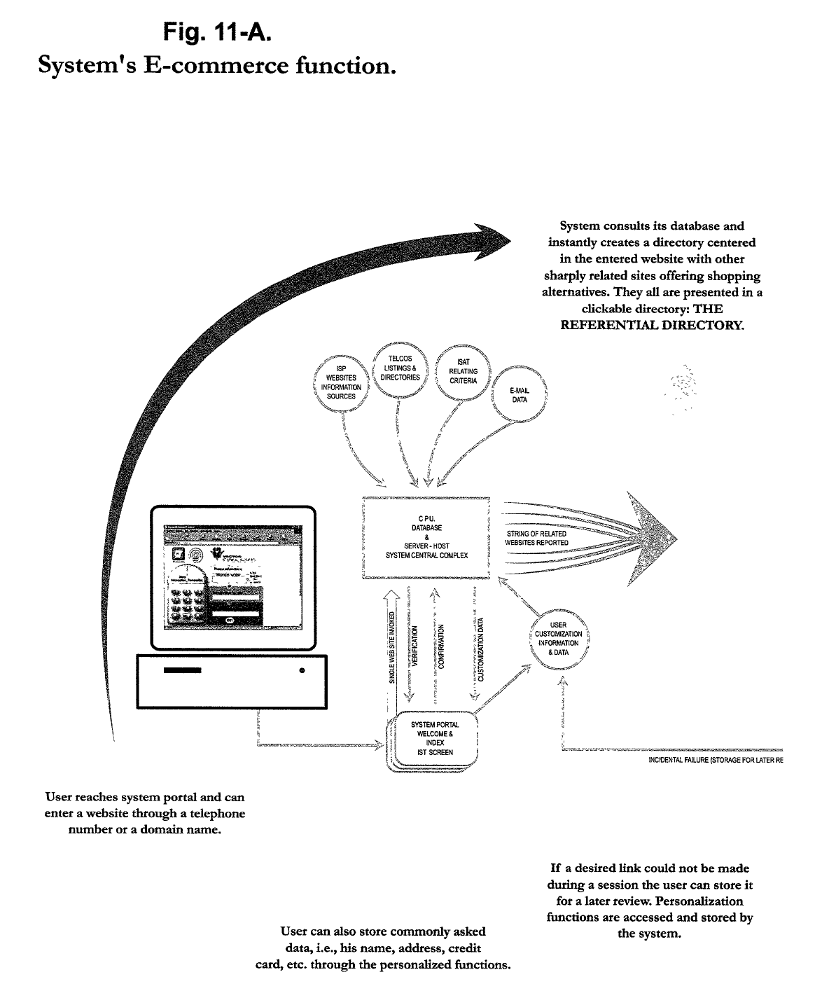

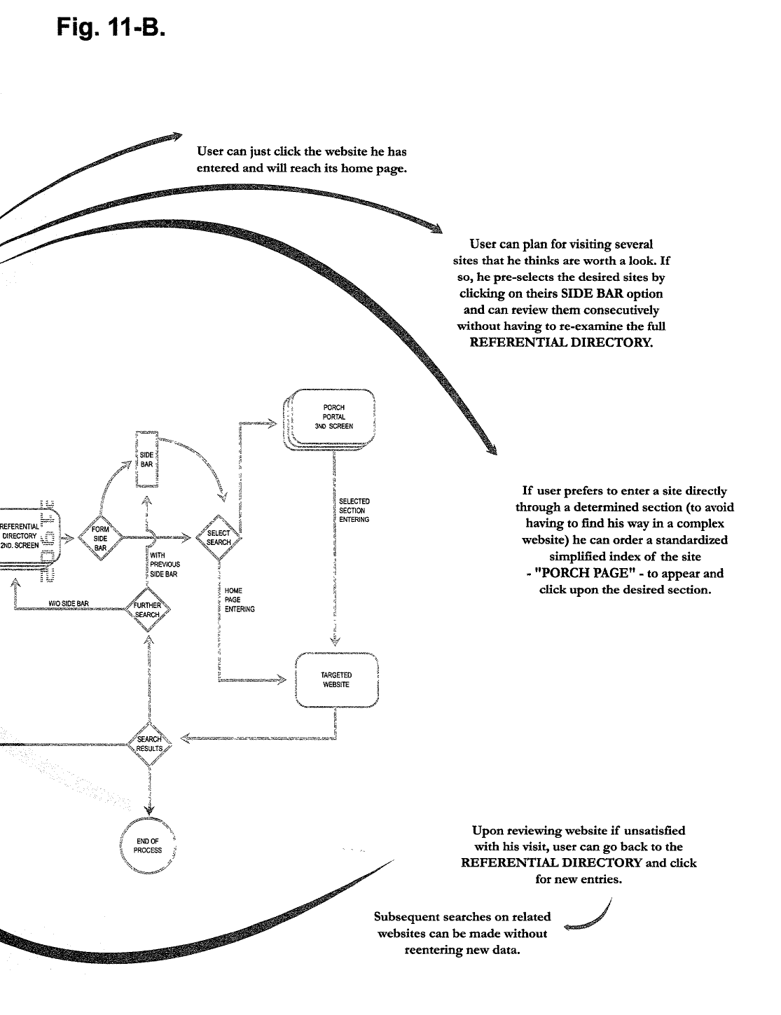

FIGS. 11A & B is a graphic illustration of the system's e-commerce function.

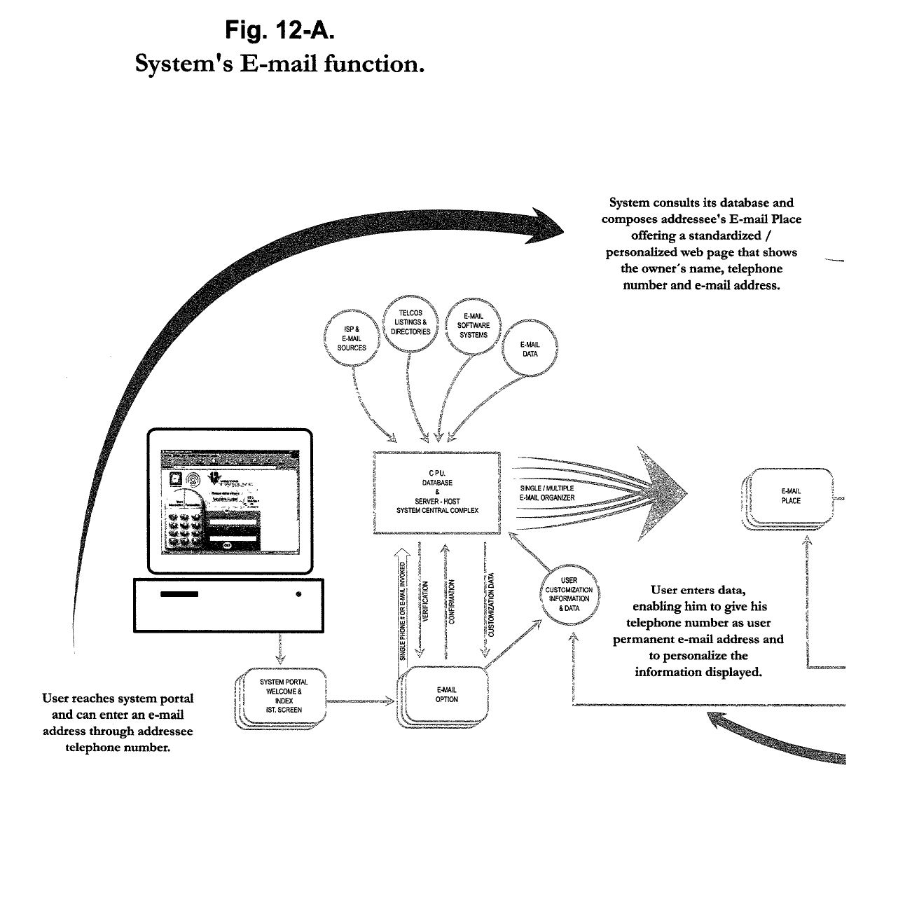

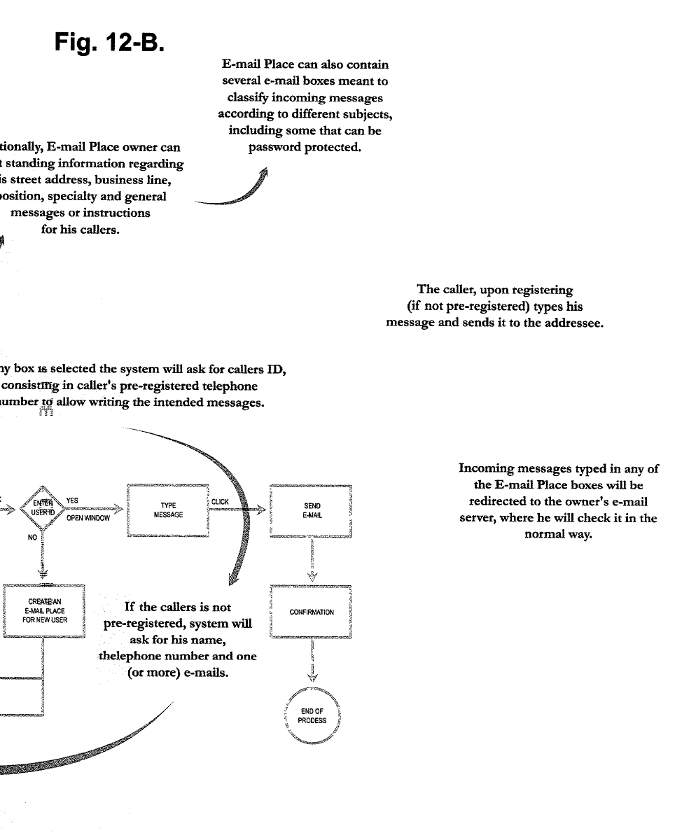

FIGS. 12A & B is a graphic illustration of the system's e-mail function.

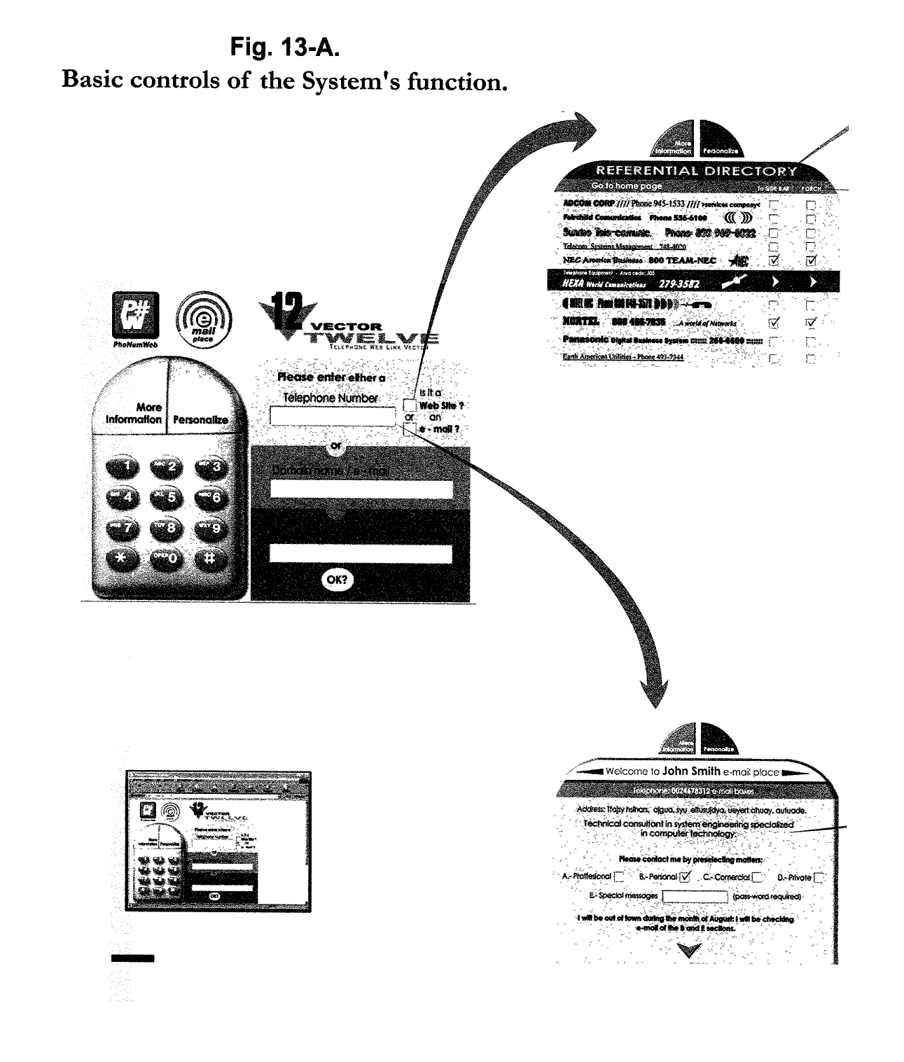

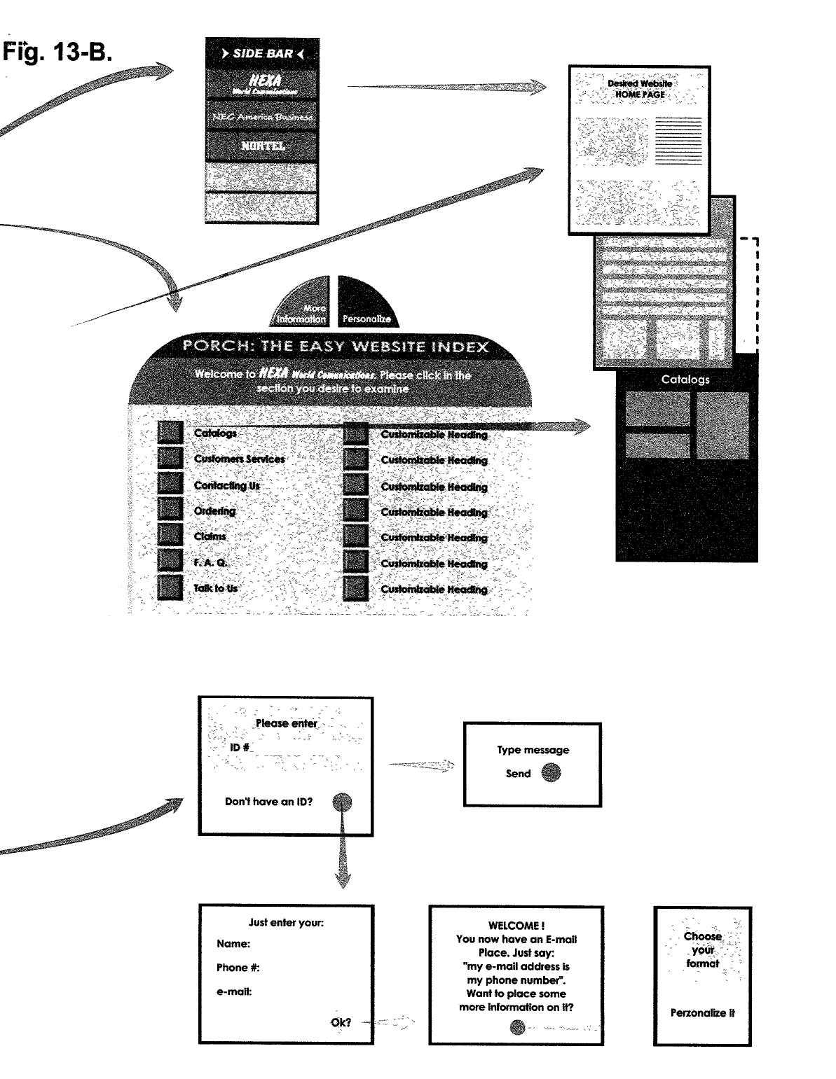

FIGS. 13A & B is a graphic illustration of the basic controls of the system's function.

### DESCRIPTION OF A PREFERRED EMBODIMENT

The present invention comprises a customizable computerized system for providing access to specified Internet websites and comparable alternative websites utilizing telephone numbers as search queries, comprising: means for receiving a system user search query for a specified Internet website in the form of either a domain name address/uniform resource locator or a telephone number corresponding to said website; means for processing said user search query to provide access to said specified Internet website in response to said query; and means for providing access to additional Internet websites that are comparable alternatives to said specified Internet website, said additional Internet websites being selected based on customizable criteria.

The present invention is also a method for providing access to specified Internet websites and comparable alternative websites utilizing telephone numbers as search queries, comprising the following steps: receiving a system user search query for a specified Internet website in the form of a telephone number corresponding to said website; processing said user search query to provide access to said specified Internet website in response to said query; selecting additional Internet websites that are comparable alternatives to said specified Internet website based on customizable criteria; and providing access to said additional Internet websites.

System Architecture.

Referring now to FIG. 1, the system architecture in a preferred embodiment includes processing means at the system end comprising a main server 10, a communications server 11, a display device 12, optionally a printer 13 and a modem 14 configured and interconnected in a conventional fashion using existing or dedicated telecommunications infrastructures to one or more central system server (“CPU”) systems 15 located at the system central complex and various remotely located CPUs or other Internet access devices 16 at the user end may communicate via known methods utilized for Internet communications, namely, data transmission across telephone or data transmission lines through gateways interfacing with the main server 10 using a protocol understood by said remote CPUs 16 (or intermediary equipment connected thereto). For example, in a preferred embodiment of the present system, data is transmitted to and from the main server 10 to remote CPUs 16 via a communications server 11 through the Internet using transmission control protocol/Internet protocol (“TCP/IP”) with conventional router/firewall components 24 and 25.

The data storage capability of the main server 10 in a preferred embodiment comprises memory connected by data and address bus lines to a random access memory and a system database mass storage device 21. The mass storage device 21 contains multiple databases such as, for example but not by way of limitation, a user database and a telephone listing and website/e-mail address databases. As with other computer systems, the system's memory provides software instructions to enable the main server 10 to execute necessary software applications programs performing system functions, including, by way of example but not by way of limitation: communications with remote CPUs 16, searching and updating; and event-driven algorithms through which the system processes requests, actions and instructions to and from users as indicated by user actions (“events”) such as pressing keys or clicking a mouse. The main server 10 includes, in a preferred embodiment, software applications for scanning telephone and URL/e-mail address directories, correlation of telephone numbers to website/e-mail addresses, classifying businesses according to type of business clientele/price level, geographic locations, and/or other criteria for classifying businesses according to similarities and other criteria of reference relevance providing information about related businesses in response to a telephone number query for one business. The system also has software applications for management and operation of the system's advertising business functions.

The main server 10 in a preferred embodiment includes proprietary data base structures and information processing business algorithms to store and process a comprehensive array of prospective, current and past users and information. The various remote CPUs 16 communicate with the main server 10 of the system. The remote CPUs 16 (Internet Client) provide local processing capability and the communications interface provides an interface to permit access by the remote users to the main server 10 and to the data bases stored on the mass storage device 21 via communication links. The communication links may be any of a wide variety of network services, such as public telephone networks, public data networks (e.g., Telenet), open virtual lines, private or public networks, ISDN, Software Defined Networks, leased dataines, etc.

Overall System Process Flow.

Referring now to FIG. 2, upon entering the system portal 16, the user is presented with the first screen 200, which contains welcome and instructions messages.

Website Invoking 210: a user can access a website from the system's home page 200 by selecting the web option and entering such website's corresponding telephone number or its URL, this causing verification data 211 to appear in the screen depicting telephone number, domain name and organization name, so the user confirms the entering 212. The system software stores and processes changes to Internet website addresses such that access to the website is provided in response to user queries using either a prior address or a changed address.

The aforementioned entering of a single website's address, causes the CPU database 400 to create a referential directory 500 that depicts such website's title and short information along with a variable number of other related websites. The referential directory is generated based on the information stored in the system's databases regarding: Internet Service Providers, website information sources 401, telephone directories and other information 402, software for processing, relating and depicting them when particular websites are invoked 403. The databases also contain information regarding e-mail data 404 to be used in connection with the e-mail functions of the system. At such referential directory, the user can form a side bar 800 auxiliary function where the user proceeds to place a variable number of preselected sites to be reviewed one at a time by consecutively clicking each one of them. The user can instead immediately click 900 on the desired listing, causing him to access 1000 the home page of the targeted website 1100. The referential directory provides access to additional Internet websites that are comparable alternatives to the user's desired website, based on customizable criteria either supplied by the user or preprogrammed into the system software. Various criteria can be used for comparison, including, without limitation, geographic location, types of products or services, prices of products or services, type of content, date of publication of content and other criteria.

In order to examine a targeted website the user can also, instead of entering it through its home page, choose 1200 the possibility offered by the “porch” portal screen 1300, which depicts in a standardized and simplified way the content of the site, and select the section 1400 of the targeted website 1100 he is primarily interested in, making it the first step of his visit.

Once the website has been examined, the user has three alternatives 1500. If the user is satisfied, he can finish his search at that point 1600. In the other hand, if a further search 1700 is desired, he can again choose between doing it through the full referential directory 500, or use the side bar function 800. Then he can choose again between using the porch portal search 1300 or go directly to the new targeted website's home page 1100. However if the intended search was not possible because of an incidental failure, such as the searched server being overloaded or a routing or other malfunction, the user can command 1800 the entering of the searched website in a user customization field 405 of the server database 400 to be placed 410 in the system's home page 200 at the user's next session. This field 405 can also be fed information by the user 220 in order to customize the system's service.

E-mail Option (FIG. 10):

To use the e-mail option 250, the user must enter 16 the system homepage 200 and select the e-mail function, a window in the screen will ask for either a phone number or e-mail of the addressee. When completed 210 the user is presented the e-mail place 701 belonging to the called party, which will show all the stored data pertaining to the addressee for confirmation, verification and instructions. The required information is gathered and stored in the system's databases from Internet Service Providers and e-mail information sources 407, telephone companies lists and directories 402, software systems 406, e-mail data 404 as well as individual applications 405.

The user is then requested to enter his ID 801, which he does if it exists (i.e., if the user has previously registered). Upon such action the user can proceed ahead 901. If no ID registry of the user exists in the system the user is requested to create 1001 an e-mail place for his use by entering his name, telephone number and one or more e-mail addresses. The entered data being immediately stored 1101 in the user customization field 405 of the system memory 400. The former makes it possible to the user to proceed 1201 through steps 801 and 901 as previously described. The user can then select 1301 a box e-mail in the screen, which causes a window to open in the screen, where the user types his message 1401 and commands it to be sent 1501. After that, he receives 1601 a sending confirmation.

Portal Pages.

Referring now to FIG. 3, the first page of the system, along with the service identification and usual welcome and use instructions and guidance, depicts a telephone key pad of the type Dual Tone Multi Function (DTMF) allowing to “dial” the desired number by clicking on it such number. FIG. 4 depicts the keypad image in a preferred embodiment of the system. Alternatively, the visitor can choose to enter such number through the keyboard, the entered number always appearing along with the website organization's name in the screen as it is entered, for verification. This verification also appears if the telephone number is dialed by interfacing a telephone key pad so it can be entered in the way it is done to effect a telephone call or if an automatic dialing is made by interfacing with a telephone memory device, whether the abovementioned interfaces are achieved through line or wireless means.

Referential Directory (FIG. 5):

Referring now to FIG. 5, the second page of the portal “Referential Directory” depicts the searched number with its corresponding organization, along with a number of other organizations offering similar or related products or services. This feature gives the user two options: That of immediately clicking on the desired number or looking at the different offerings and possibilities available. If the former option is selected, the visitor has yet the possibility of easily (one click) going back to the listing of the referential directory if he happens not to find a satisfactory result for what he was looking for.

Side Bar Preselection (FIG. 8):

The option of conducting a previous search, in turn, can be effected on a plain visual way in the Referential Directory or by pre-selecting in its listing a number of websites for a later consecutive review. In this case a side bar would appear on the screen, the visitor being able to recall such side bar repeatedly in order to click consecutively in its different entries.

By using the side bar system function, users can construct search helping devices to program their intended search, much in the manner consumers do while using the phone directory by manually highlighting entries to easily recognize them as they proceed their checking of those perceived as likely shopping alternatives. The side bar performs that function in an automated way (by clicking), which in turn can be automatically processed (also by clicking on entries).

Website Porch (FIG. 7):

The portal format of the system allows for yet another added value feature, that of providing certain websites with a standardized, uniform and clear pre-home page (a third screen, the “porch screen”) portraying the index and features contained in the website in order to ease the inconvenience many Internet users face when exploring multiple websites each containing different formats which wildly vary from each other, making it disruptive to jump from one website to the next. From such standardized pre-home pages, the user can enter directly the particular web page or section included in a website which he is interested in examining, allowing for that section to be the first step of the visit to that website. This embodiment encourages the Internet-assisted shopping by adding convenience and easing the task of examining commercial websites.

Porch pages standardized models would aim to adapt to different business types in order to accommodate typical common major sections of corresponding websites, with some blank headings to allow partial customization by the pertaining organization.

Accessing and using the system regarding Internet shopping.

The system is presented in the form of an Internet portal. For the purpose of accessing a website by entering a corresponding telephone number, the user of the system accesses the system portal through his Internet access device (i.e., PC, set top box, etc.). The system portal's first screen, the “welcome/instructions” screen, greets the visitor and offers instructions and possibilities as well as a keypad image of the DTMF type. The visitor then enters such telephone number causing the appearance of a second screen, the “referential directory” screen, in which the desired website is included, identified by the organization's name and telephone number, along with various other websites offering similar or related products or services, all of them arranged by the system in order to facilitate to the user visiting suitable alternative sites and conferring a variable degree of preference to those alternative organizations as agreed with them. A click on the desired website puts on the screen the desired home page.

Data gathering consists of transcribing and compiling in a server data base the domains from the proper sources i.e., domain name registrars, Internet Service Providers (ISP) and automatic search through the Internet by means of search engines, coupling the information regarding websites with telephone numbers by means of telephone directories and companies. Such information is constantly updated and enlarged by revising the aforementioned sources, and to by taking applications from ISP, telephone companies and websites owners. Once the information is entered to the server database, the search of the website by invoking the telephone number would be achieved by means of a common hyperlink according to the HTML Internet standards.

The present invention operates within the present state of the Domain Name System/URL Internet standards, that is, without waiting for any change in standards regarding the ENUM telephone number mapping, nor any development in number portability as proposed by supplement to ITU-T Recommendation El 64 (the international public telecommunication numbering plan) nor any other change in either the Internet Protocol nor the telephone numbering plans, since it is applicable to the present protocols, plans and systems and to any such standards which would eventually be applied in the future. No translation, transformation, manipulation in either code (URL/DNS or telephone numbering plan) is involved and no change in either is necessary for the system to operate. Should any change occur, it would only entail the need to update the database, so its validity remains unaffected by any change to occur in the URL, DNS, the North American Numbering Plan or any future development of the ENUM standard. Likewise it is applicable to any telephone numbering system around the world since the system is nondependent on any technology interrelating, unifying, translating, mapping or standardizing phone numbers or addresses with IP addresses and it only relays on the HTML hyperlink standard. It could indeed be used to facilitate any massive change of addresses that would occur as a consequence of enacting the ENUM-ITU-TE 164 standard.

The system offers to users and websites a way of addressing and accessing to business and electronic commerce that is unrestricted and free. The system proves particularly useful when the user knows the website organization's corresponding telephone number and when he has conducted a previous search through any telephone directory (printed or electronic) or has stored it in any way for his subsequent use. The method of retrieving web pages by means of a corresponding telephone number and using the assistance features provided by the system is particularly suitable when the consumer prefers to write down a number instead of a domain name because of it being less likely to make mistakes while writing it down or while entering it in a computer or any other Internet access device as palm tops, cellular phones or set top boxes, or desires to keep just one way of accessing an organization which is good for telephone or Internet use, or when he intends to contact it both ways in order, for example, to review the features depicted in the organization's web page and then, eventually refining his search through a telephone call which could by effected either through Internet telephony or by an ordinary telephone call in order to further a transaction, this being facilitated by storing the number used to access the web page for easy retrieval if and when desired.

Besides offering an alternative way to access web pages and providing a manner of unifying web and telephone addressing for organizations, the system contains additional features in the different pages included in its portal.

Method of Doing Business Utilizing the System of the Present Invention, Regarding E-commerce

The system can be utilized to practice a method of doing business based on service providing, advertising, sales and revenues having the following characteristics:

All websites are included in the system database, regardless of payment in order to guarantee consumers the universal access to all websites.

Businesses can have their information highlighted, advertised or preferentially displayed as an alternative business search result listing in exchange for advertising revenues.

Business are provided with an updating service so that when a business changes its telephone number, website address, or other contact information, the updating provides both telephone numbers, (the updated one and the outdated one), for a determined period of time, for information on the occurrence, or in case of any change of domain name occurred to the web page, also to warn visitors about that occurrence and avoid the searched website loose the intended contacts.

The system also allows users to store by means of “cookies” or other common method those telephone numbers used to access websites in order to automatically recall them if the user desires to make a telephone call to the same party during his Internet session whether by means of Internet telephony or ordinary voice or facsimile telephone call.

The system users can also store and compile the telephone numbers used as access to websites in order to form a personal telephone web-enabled number directory, arranged in alphabetical or any other predetermined order. The format can be made suitable for printing to allow users to save printed personal directories to be used in other computers.

System Options and Possibilities.

Each time a request comes for a certain customer number and serial number, a counter is incremented. This counting system provides a basis for advanced reporting functions, such as demographics versus hit rate, location versus hit rate, etc. The system of the present invention also can catalog end-user usage of the system on a per-use basis. Each time the browser is loaded, the number of the browser relative to all like-customized browsers (the “serial number”) is sent over the Internet using a secure Internet protocol. This information reaches an IP address on the Internet capable of receiving and processing response and requests of this protocol, which will store this data in a permanent datastore, which supports various reporting functions including i.e. for overloaded servers. It would permit to store the failed link attempts in order to command a later search at a less congested time.

The system is helpful when a user desires to make an exploratory search of alternatives since it provides a structured search of alternatives in the referential directory by means of clicking with that purpose on the chosen alternatives, thus placing them in a side bar for a later consecutive examination by clicking each, one at a time. This kind of alternatives searching is a common pattern of yellow pages users and it is greatly assisted by the automated way provided for by the system portal.

When possessing the telephone number of a website it can be used more practically and rewardingly by entering the number via a personal computer keyboard or set top box, than it would be making the phone call and waiting to hear the message system of a telephone answerer.

Users use the portal in the same manner as a telephone book, or after using it as a previous searching device and start an Internet session which will allow the user to a more rewarding result than can be achieved through telephone calling: more information, instant alternatives search, order preparation and on-line ordering possibilities, better targeting accuracy and also more relevant secondary entries than search engines can offer and speedier information than telephone call exploring can provide. Remedy is also offered for cases oftelephone, domain name or URL changes, in which cases the system would still provide the desired contact. Likewise failed links can be stored for later recalls.

Method of Doing Business Regarding E-Mail.

The system provides access not only to website addresses, but also to individual e-mail addresses corresponding to individual telephone numbers. The system provides an e-mail address locating and organizing service based on individual telephone numbers, including all or some of the following functions, as customizable by the user:

Identification function depicting name, telephone number and e-mail address; performing a verification function.

An addition to the former, depicting additional information as profession or business line, specialty, position in a company or organization, street address, etc.; performing a positioning function.

A multiple e-mail addressing service for a single recipient instructing visitors to use different e-mail boxes for corresponding different matters i.e. personal, business, appointments, inquiries, applications, etc.; performing a sorting function.

A password function to restrict one or more of a set of e-mails boxes with corresponding passwords or other available systems of origin authentication and/or verification, in order to allow the recipient preferential review of some of them; performing an access restriction function.

A special section allowing answering-service-style general messages for parties addressing to e-mail owner, and/or mailbox choice instructions in an analogous form of automatic answerers; enriching standing communication from the owner of the email place.

E-mail addresses corresponding to business or organizations can include, by means of multiple boxes, multiple addresses (whether for employees, departments or sections) to facilitate the sorting of incoming messages; performing a classification function.

In order to access these features, the user can also enter, instead of the called party's telephone number, a corresponding e-mail address. The system will request entering an existing ID or creating a new one for the user (in the manner explained in the e-mail flowchart description). This ID, consists in the caller's telephone number which will have to be entered along with his name and one or more e-mail addresses belonging to them. Upon entering this information, a new E-Mail place will be created for the user allowing him to have his phone number used to directly access his e-mail by his acquaintances. As the user proceeds, he can select a box causing the usual e-mail message window to appear and allowing the sender to type his message and command it to be sent just by a click, with no further address entering being necessary. E-mail subportal would be offered in combination with the website search portal in order to stimulate its use. A sample e-mail sub-portal screen of the system of the present invention is depicted in FIGS. 9A and 9B, and FIG. 10 is a flowchart diagram describing the process of the present invention regarding the e-mail organizing function in a preferred embodiment.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative and other embodiments may be selected without departing from the spirit and scope of the present invention.

What is claimed is:

1. A customizable computerized system for providing access to specified Internet websites and comparable alternative websites utilizing telephone numbers as search queries, comprising:
means for receiving a system user search query for a specified Internet website in the form of a telephone number corresponding to said website;
means for processing said user search query to provide access to said specified Internet website in response to said query; and
means for providing access to additional Internet websites that are comparable alternatives to said specified Internet website, said additional Internet websites being selected based on customizable criteria.

2. The system of claim 1, further comprising means for processing changes to Internet website addresses such that access to said websites is provided in response to user queries using either a prior address or a changed address.

3. The system of claim 1, further comprising means for displaying to users content from said Internet websites in a standardized format.

4. The system of claim 1, wherein said customizable criteria are provided by electronic communication from said user.

5. The system of claim 1, wherein said customizable criteria are preprogrammed into said system.

6. The system of claim 1, wherein said means for providing access to additional Internet websites that are comparable alternatives to said specified Internet website based on customizable criteria comprises one or more databases containing data regarding characteristics of a plurality of Internet websites and one or more software applications that select said additional websites based on comparison of data pertaining to said specified website and data pertaining to said additional websites.

7. The system of claim 6, wherein said one or more software applications select additional websites based on comparison of information regarding the geographic location of the proprietors of the websites being compared.

8. The system of claim 6, wherein said one or more software applications select additional websites based on comparison of information regarding the products or services offered by the websites being compared.

9. The system of claim 6, wherein said one or more software applications select additional websites based on comparison of information regarding the prices for products or services offered by the websites being compared.

10. The system of claim 6, wherein said one or more software applications select additional websites based on comparison of information regarding the type of content provided by the websites being compared.

11. The system of claim 6, wherein said one or more software applications select additional websites based on comparison of information regarding the date of publication of content provided by the websites being compared.

12. The system of claim 1, further comprising means for receiving a system user search query for a specified electronic mail recipient in the form of a telephone number corresponding to said recipient;
means for processing said user search query to provide information pertaining to said recipient; and
means for sending electronic mail to said recipient.

13. The system of claim 12, wherein said means for sending electronic mail to said recipient further comprises means for sending said electronic mail to multiple alternate electronic mail addresses corresponding to said recipient, said alternate electronic mail addresses being selected based on customizable criteria.

14. A method for providing access to specified Internet websites and comparable alternative websites utilizing telephone numbers as search queries, comprising the following steps:
receiving a system user search query for a specified Internet website in the form of a telephone number corresponding to said website;
processing said user search query to provide access to said specified Internet website in response to said query;
selecting additional Internet websites that are comparable alternatives to said specified Internet website based on customizable criteria; and
providing access to said additional Internet websites.

15. A customizable computerized system for providing access to specified Internet websites and comparable alternative websites, comprising:
means for receiving a system user search query for a specified Internet website;
means for processing said user search query to provide access to said specified Internet website in response to said query; and
means for providing access to additional Internet websites that are comparable alternatives to said specified Internet website, said additional Internet websites being selected based on customizable criteria.

16. The system of claim 15, wherein search user query is in the form of a Domain Name.

17. The system of claim 15, further comprising means for processing changes to Internet website addresses such that access to said websites is provided in response to user queries using either a prior address or a changed address.

18. The system of claim 15, further comprising means for displaying to users content from said Internet websites in a standardized format.

19. The system of claim 15, wherein said customizable criteria are provided by electronic communication from said user.

20. The system of claim 15, wherein said customizable criteria are preprogrammed into said system.

21. The system of claim 15, wherein said means for providing access to additional Internet websites that are comparable alternatives to said specified Internet website based on customizable criteria comprises one or more databases containing data regarding characteristics of a plurality of Internet websites and one or more software applications that select said additional websites based on comparison of data pertaining to said specified website and data pertaining to said additional websites.

22. The system of claim 21, wherein said one or more software applications select additional websites based on comparison of information regarding the geographic location of the proprietors of the websites being compared.

23. The system of claim 21, wherein said one or more software applications select additional websites based on comparison of information regarding the products or services offered by the websites being compared.

24. The system of claim 21, wherein said one or more software applications select additional websites based on comparison of information regarding the prices for products or services offered by the websites being compared.

25. The system of claim 21, wherein said one or more software applications select additional websites based on comparison of information regarding the type of content provided by the websites being compared.

26. The system of claim 21, wherein said one or more software applications select additional websites based on comparison of information regarding the date of publication of content provided by the websites being compared.
